(19) United States
(12) Patent Application Publication
(10) Pub. No.: US 2013/0064112 A1
(43) Pub. Date: Mar. 14, 2013

(54) Method of Handling Adaptive Modulation and Coding and Related Communication Device

(71) Applicants: Wei-Shun Liao, Taipei City (TW); Hsuan-Jung Su, Taipei City (TW); Yu-Chih Jen, Taoyuan County (TW)

(72) Inventors: Wei-Shun Liao, Taipei City (TW); Hsuan-Jung Su, Taipei City (TW); Yu-Chih Jen, Taoyuan County (TW)

(21) Appl. No.: 13/411,654

(22) Filed: Mar. 5, 2012

Related U.S. Application Data
(60) Provisional application No. 61/449,090, filed on Mar. 4, 2011.

(51) Int. Cl. H04W 24/00

(52) U.S. Cl. 370/252

(57) ABSTRACT

A method of determining a modulation and coding scheme (MCS) for a next hybrid automatic repeat request (HARQ) transmission for a receiver in a wireless communication system is disclosed. The method comprises measuring signal quality of a present HARQ transmission when receiving complete information transmitted by a transmitter of the wireless communication system in the present HARQ transmission; determining normalized signal quality according to the signal quality and remaining part of the complete information to be received in the next HARQ transmission; and determining the MCS according to the normalized signal quality, for processing the remaining part of the complete information according to the MCS.

### CROSS REFERENCE TO RELATED APPLICATIONS

This application claims the benefit of U.S. Provisional Application No. 61/449,090, filed on Mar. 4, 2011 and entitled “Methods and Apparatus for Adaptive Modulation and Coding of Wireless Communication Systems with Variable Transmission Time and Bandwidth”, the contents of which are incorporated herein in their entirety.

### BACKGROUND OF THE INVENTION

1. Field of the Invention

The present invention relates to a method used in a wireless communication system and related communication device, and more particularly, to a method of handling adaptive modulation and coding and related communication device.

2. Description of the Prior Art

A hybrid automatic repeat request (HARQ) process is used in a communication system to provide both efficient and reliable communications. Different from an ARQ process, a forward error correcting code (FEC) is used for the HARQ process. For example, a receiver feeds back an acknowledgment (ACK) to inform a transmitter that a packet has been received correctly if the receiver decodes the packet correctly. Oppositely, the receiver feeds back a negative acknowledgment (NACK) to the transmitter if the receiver cannot decode the packet correctly. In this situation, the receiver stores part or whole of the packet in a soft buffer of the receiver. After the receiver receives a retransmitted packet from the transmitter, the receiver decodes the stored packet and the retransmitted packet jointly, to recover the packet. Thus, the packet can be recovered correctly with a high probability. The receiver continues the HARQ process (i.e., accumulates retransmitted packets) until the packet is decoded correctly. Since the packet with few errors can be correctly decoded by using the FEC without feeding back the NACK, i.e., requesting a retransmission, and the packet with more errors can be correctly decoded by combining the retransmitted packets, throughput of the communication system is increased due to fewer retransmissions.

On the other hand, adaptive modulation and coding (AMC) is an effective way for improving the throughput of the communication system. When the AMC is operated, the transmitter adaptively adjusts modulation and coding scheme (MCS) used in a transmission (e.g. new transmission or retransmission) according to signal quality (e.g. signal-to-noise ratio (SNR)) such that the throughput is maximized. In detail, the transmitter uses the MCS with more redundancy (i.e., low data rate) to process data in the transmission when the signal quality is bad, and the transmitter uses the MCS with less redundancy (i.e., high data rate) to process the data in the transmission when the signal quality is good. Thus, tradeoff between the throughput and reliability of the transmission can be properly made. Further, when the AMC is applied to the HARQ process (i.e., retransmissions in the HARQ process), an amount of the retransmissions can be decreased.

For example, please refer to FIG. 1, which is a schematic diagram of throughputs of the receiver using different MCSs according to the prior art. In FIG. 1, MCSs MCS1-MCS3 represents MCSs with increasing data rates (i.e. decreasing amounts of redundancy). For example, the MCS1 represents quadrature phase-shift keying (QPSK) modulation with a code rate of ½, the MCS2 represents 16-quadrature amplitude modulation (QAM) with the code rate of ½, and the MCS3 represents 64QAM with the code rate of ⅔. As shown in FIG. 1, range of the SNR can be divided into 3 SNR regions SR1-SR3. The receiver can achieve an optimal throughput denoted by circles, if the MCSs MCS1-MCS3 are selected for the SNR regions SR1-SR3, respectively. For example, if an SNR of 20 dB is measured by the receiver, the MCS MCS2 is selected.

However, the SNR cannot be perfectly known by the receiver, since a channel between the transmitter and the receiver varies all the time. That is, a measurement error exists between a measured SNR and actual SNR. Thus, the receiver may select a wrong MCS according to the measured SNR. For example, please refer to FIG. 2, which is a schematic diagram of throughputs of the receiver according to the prior art, wherein the optimal throughput achieved by the actual SNR (i.e., the circles in FIG. 1) and a practical throughput achieved by the measured SNR are shown. From the practical throughput shown in FIG. 2, there is throughput loss caused by the measurement error, and the throughput loss is particularly large at boundaries between the SNR regions SR1-SR3. A main reason is that differences of the throughputs achieved by using different MCSs are particularly large at the boundaries between the SNR regions SR1-SR3 as shown in FIG. 1. Besides, the SNR regions SR1-SR3 are usually determined according to simulation results obtained in a laboratory, and can not be matched perfectly to the channel which varies all the time. That is, the throughput loss is still caused due to the SNR regions SR1-SR3, even though the receiver can measure the SNR perfectly. Therefore, how to reduce the measurement error of the SNR caused by variation of the channel and mismatch caused by different SNR regions is an important topic to be discussed and addressed, so as to correctly select the MCS according to the measured SNR.

### SUMMARY OF THE INVENTION

The present invention therefore provides a method and related communication device for handling adaptive modulation and coding to solve the abovementioned problems.

A method of determining a modulation and coding scheme (MCS) for a next hybrid automatic repeat request (HARQ) transmission for a receiver in a wireless communication system is disclosed. The method comprises measuring signal quality of a present HARQ transmission when receiving complete information transmitted by a transmitter of the wireless communication system in the present HARQ transmission; determining normalized signal quality according to the signal quality and remaining part of the complete information to be received in the next HARQ transmission; and determining the MCS according to the normalized signal quality, for processing the remaining part of the complete information according to the MCS.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram of throughputs of the receiver using different MCSs according to the prior art.

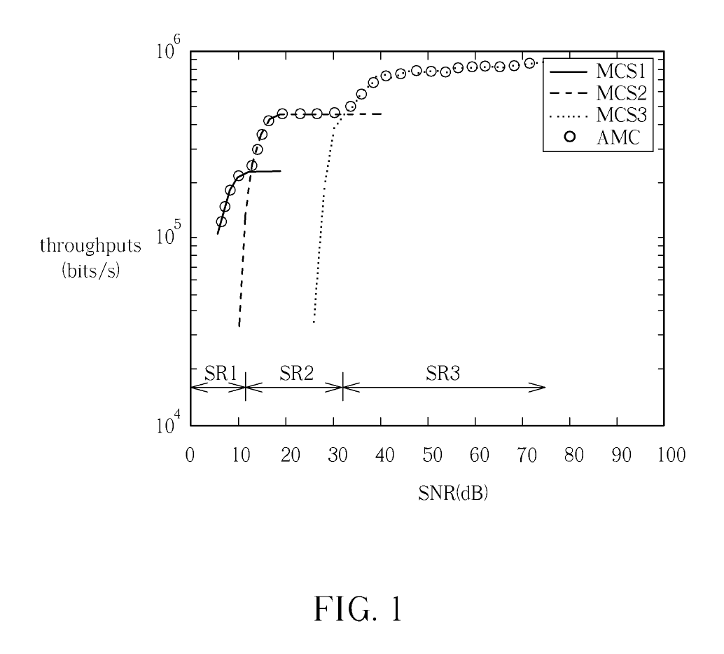

FIG. 2 is a schematic diagram of throughputs of the receiver according to the prior art.

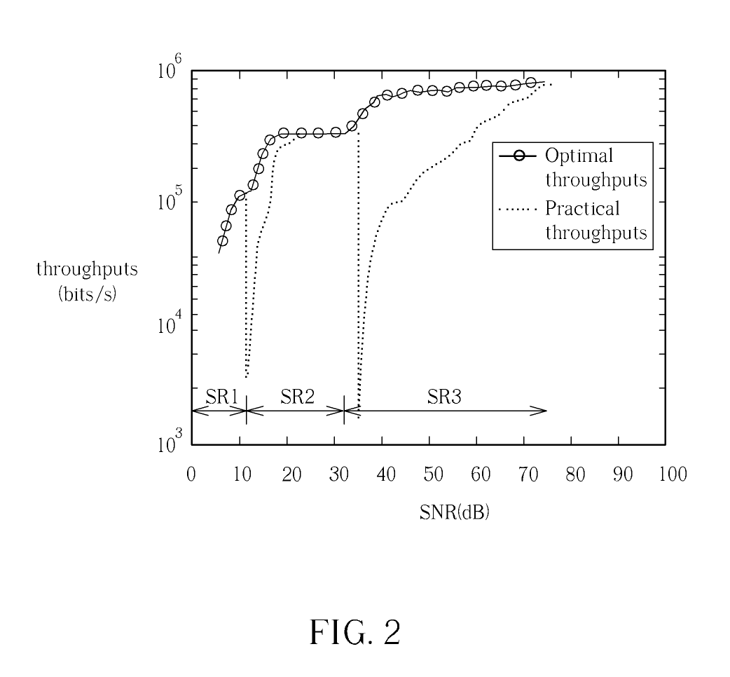

FIG. 3 is a schematic diagram of a wireless communication system according to an example of the present invention.

FIG. 4 is a schematic diagram of a communication device according to an example of the present invention.

FIG. 5 is a flowchart of a process according to an example of the present invention.

### DETAILED DESCRIPTION

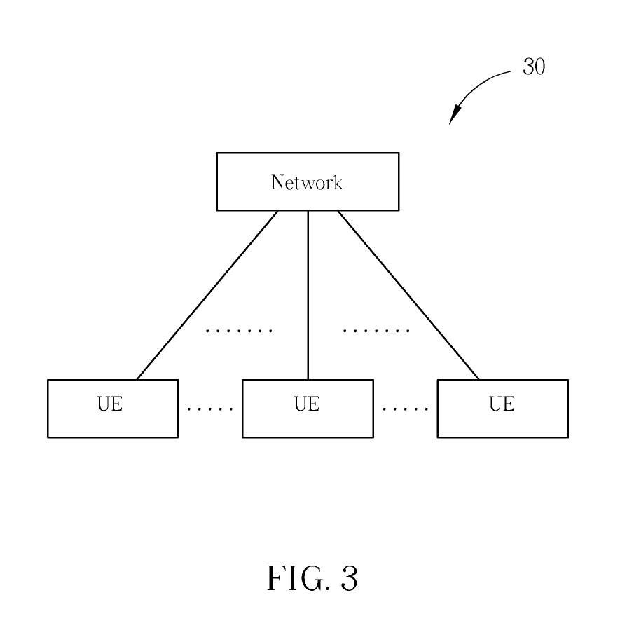

Please refer to FIG. 3, which is a schematic diagram of a wireless communication system 30 according to an example of the present invention. The wireless communication system 30 is briefly composed of a network and a plurality of user equipments (UEs). The network and the UEs can apply adaptive modulation and coding (AMC) to a hybrid automatic repeat request (HARQ) transmission. That is, the network and the UEs are capable of determining (e.g. selecting) a modulation and coding scheme (MCS) for the HARQ transmission according to signal quality. In FIG. 3, the network and the UEs are simply utilized for illustrating the structure of the wireless communication system 30. Practically, the network can be a universal terrestrial radio access network (UTRAN) comprising a plurality of Node-Bs (NBs) in a universal mobile telecommunications system (UMTS). Alternatively, the network can be an evolved UTRAN (E-UTRAN) comprising a plurality of evolved NBs (eNBs) and relays in a long term evolution (LTE) system or a LTE-Advanced (LTE-A) system. Further, the network can be an access point (AP) conforming to the IEEE 802.11 standard, and is not limited herein. The UEs can be mobile devices such as mobile phones, laptops, tablet computers, electronic books, and portable computer systems. Besides, the network and a UE can be seen as a transmitter or a receiver according to transmission direction, e.g., for an uplink (UL), the UE is the transmitter and the network is the receiver, and for a downlink (DL), the network is the transmitter and the UE is the receiver.

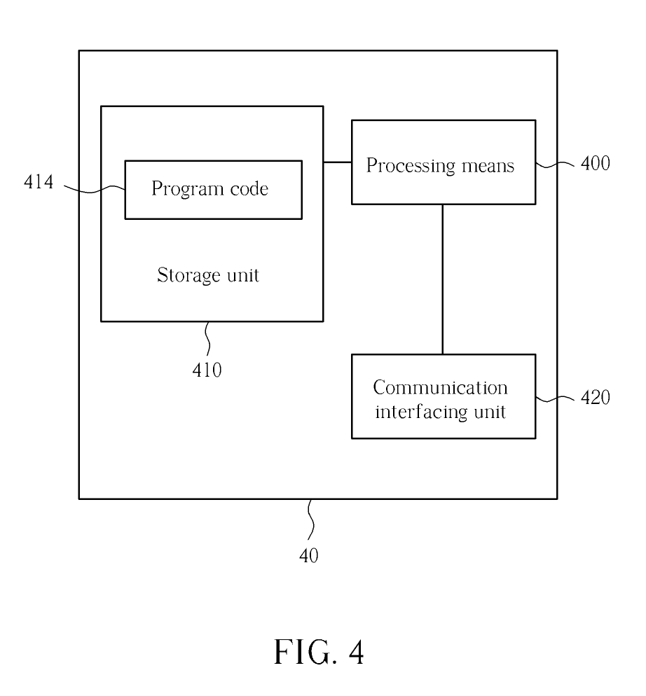

Please refer to FIG. 4, which is a schematic diagram of a communication device 40 according to an example of the present invention. The communication device 40 can be a UE or the network shown in FIG. 3, but is not limited herein. The communication device 40 may include a processing means 400 such as a microprocessor or an Application Specific Integrated Circuit (ASIC), a storage unit 410 and a communication interfacing unit 420. The storage unit 410 may be any data storage device that can store a program code 414, accessed by the processing means 400. Examples of the storage unit 410 include but are not limited to a subscriber identity module (SIM), read-only memory (ROM), flash memory, random-access memory (RAM), CD-ROM/DVD-ROM, magnetic tape, hard disk, optical data storage device and solid-state drive (SSD). The communication interfacing unit 420 is preferably a radio transceiver and can transmit and receive wireless signals according to processing results of the processing means 400.

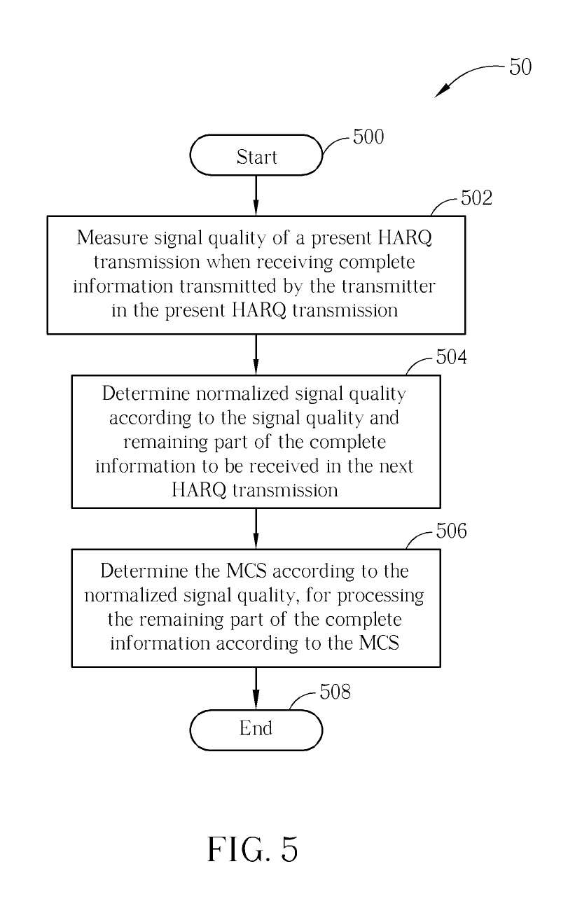

Please refer to FIG. 5, which is a flowchart of a process 50 according to an example of the present invention. The process 50 is utilized in a receiver which may be a UE or the network shown in FIG. 3, for handling the AMC, i.e., determining a MCS for a next HARQ transmission. When the UE is the transmitter, the network is the receiver; when the network is the transmitter, the UE is the receiver. The process 50 may be compiled into the program code 414 and includes the following steps:

Step 500: Start.

Step 502: Measure signal quality of a present HARQ transmission when receiving complete information transmitted by the transmitter in the present HARQ transmission.

Step 504: Determine normalized signal quality according to the signal quality and remaining part of the complete information to be received in the next HARQ transmission.

Step 506: Determine the MCS according to the normalized signal quality, for processing the remaining part of the complete information according to the MCS.

Step 508: End.

According to the Step 502, the receiver measures signal quality of a present HARQ transmission when receiving complete information (e.g. a data unit, a packet, a frame, etc.) transmitted by the transmitter in the present HARQ transmission. Note that the term “HARQ transmission” in the process 50 may be the first (new) HARQ transmission or a HARQ retransmission. The signal quality can be any information related to quality of a signal received by the receiver. For example, the signal quality is generally represented as signal-to-noise ratio (SNR), but not limited herein. According to Step 504, the receiver determines normalized signal quality according to the measured signal quality and remaining part of the complete information, which is apart of the transmitted complete information which has not been successfully received in the present HARQ transmission. The remaining part of the complete information left to be transmitted can be evaluated by the receiver, which is described later.

Then, according to Step 506, the receiver determines the MCS applied in the next HARQ transmission (which may be a HARQ retransmission) according to the normalized signal quality. After the MCS has been determined, the receiver transmits information of the determined MCS to the transmitter, for processing (e.g. modulating, encoding and/or transmitting) the remaining part of the complete information in the next HARQ transmission according to the MCS. In other words, when determining the MCS, the receiver considers not only the measured signal quality, but also the remaining information. Therefore, a measurement error caused by the measured signal quality is reduced. As a result, the receiver can correctly determine the MCS according to the normalized signal quality, and throughput loss of the receiver can be reduced accordingly.

Please note that, a spirit of the process 50 is that the receiver determines the MCS according to the normalized signal quality which is related to both the measured signal quality and the remaining information left to be transmitted to the receiver.

According to the above illustration, a realization of the process 50 is illustrated as follows. Effective information received by a receiver in an n-th HARQ transmission can be represented according to the following equation:

Cₙ=log₂(1+\hat{ρ}ₙ) (Eq. 1),

wherein \hat{ρ}ₙ is an SNR measured by the receiver in (or near) the n-th HARQ transmission, which is obtained by Step 502. The effectively-received information Cₙ can be seen as information which is received correctly and effectively in a theoretical sense in the n-th HARQ transmission. In a communication system with variable size of transmission resources, the SNR \hat{ρ}ₙ can be evaluated by averaging SNRs of multiple resource blocks which are identified by time symbols and frequency bands, and are not limited. The receiver further determines the remaining information according to accumulated received information stored in the receiver and complete information scheduled for the receiver. The remaining information C^{k} (in the theoretical sense) left to be transmitted in a k-th HARQ transmission can be represented according to the following equation:

$${C}^{k} = R - {\sum }_{n = 1}^{k - 1} {C}_{n} , \qquad ( Eq . 2 )$$

wherein R is complete information (e.g. a data unit, a packet, a frame, etc.) scheduled to be transmitted to the receiver, and

$${\sum }_{n = 1}^{k - 1} {C}_{n}$$

is accumulated received information stored in the receiver and is collected from k−1 previous HARQ transmissions. The receiver further determines a normalized SNR by Step 504. A normalized SNR \tilde{ρ}ₖ for the k-th HARQ transmission can be represented according to the following equation:

$${\tilde{ρ}}_{k} = \frac{{\hat{ρ}}_{k}}{{C}^{k}} , \qquad ( Eq . 3 )$$

wherein effect of the SNR \hat{ρ}ₖ is normalized by the remaining information C^{k}, e.g. the measured SNR \hat{ρ}ₖ is divided by the remaining information C^{k}. Please note that, since the k-th HARQ transmission does not happen at this time, the SNR \hat{ρ}ₖ can not be measured in the k-th HARQ transmission, and the SNR \hat{ρ}ₖ can be replaced by a SNR just measured before the k-th HARQ transmission in the equation (Eq. 3). Therefore, the MCS applied in the next HARQ transmission can be determined according to the normalized SNR \tilde{ρ}ₖ. The MCS is then fed back to the transmitter such that the transmitter can process (e.g. modulate, encode and/or transmit) the remaining information for the k-th HARQ transmission according to the MCS. The above illustration continues until the complete information is correctly received by the receiver.

The above realization of the process 50 is only an example to derive the normalized signal quality and any other method for deriving the normalized signal quality can also be used in the process 50, as long as the measurement error caused by the measured signal quality can be reduced.

Besides, the receiver can determine the MCS by locating the normalized signal quality in one of a plurality of signal quality regions. Preferably, the plurality of signal quality regions can be determined according to at least one threshold. That is, range of the normalized signal quality is divided by using the at least one threshold, for establishing the plurality of signal quality regions. Please note that, the at least one threshold is usually determined (e.g. estimated) according to simulation results obtained in a laboratory, and is not perfectly matched to a channel between the transmitter and the receiver. The throughput loss is caused event though the receiver can measure the signal quality perfectly. Thus, one of the at least one threshold can be adjusted according to a previous HARQ transmission received by the receiver. That is, the at least one threshold (and thus the plurality of quality regions) can be dynamically adjusted, to match the channel better. The throughput loss can be further reduced by using both the normalized signal quality and the dynamically adjusted thresholds.

For example, J SNR regions are assumed to be used for determining MCSs, wherein each SNR region corresponds to a MCS. Range of the normalized SNR \tilde{ρ}ₖ can be divided into the J SNR regions by using J−1 thresholds {Γₙ:n=1, . . . , J−1}. After the receiver locates the normalized SNR \tilde{ρ}ₖ in one of the N_{R} SNR regions, i.e., \tilde{ρ}ₖε[Γₘ₋₁, Γₘ) is determined, a corresponding MCS for the kth HARQ transmission can be determined. The thresholds and thus the SNR regions can be dynamically adjusted for further improving performance of the receiver.

Please note that, the abovementioned steps of the processes including suggested steps can be realized by means that could be a hardware, a firmware known as a combination of a hardware device and computer instructions and data that reside as read-only software on the hardware device, or an electronic system. Examples of hardware can include analog, digital and mixed circuits known as microcircuit, microchip, or silicon chip. Examples of the electronic system can include a system on chip (SOC), system in package (SiP), a computer on module (COM), and the communication device 40.

To sum up, the present invention provides a method utilized in a receiver which can be the UE or the network, for determining a MCS for a next HARQ transmission, to reduce a measurement error caused by measured signal quality. The measured signal quality is normalized by remaining part of complete information such that the measurement error is also normalized (i.e., reduced). Therefore, the receiver can correctly determine the MCS, and throughput loss of the receiver can be reduced accordingly.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method of determining a modulation and coding scheme (MCS) for a next hybrid automatic repeat request (HARQ) transmission for a receiver in a wireless communication system, the method comprising:
measuring signal quality of a present HARQ transmission when receiving complete information transmitted by a transmitter of the wireless communication system in the present HARQ transmission;
determining normalized signal quality according to the signal quality and remaining part of the complete information to be received in the next HARQ transmission; and
determining the MCS according to the normalized signal quality, for processing the remaining part of the complete information according to the MCS.

2. The method of claim 1, further comprising:
determining the remaining part of the complete information according to accumulated information stored in the receiver and the complete information.

3. The method of claim 2, wherein the accumulated information is determined according to the signal quality measured by the receiver in at least one previous HARQ transmission.

4. The method of claim 3, wherein each part of the accumulated information is determined according to the signal quality measured by the receiver in a corresponding HARQ transmission of the at least one previous HARQ transmission.

5. The method of claim 1, wherein the normalized signal quality is a function of the signal quality and the remaining part of the complete information.

6. The method of claim 1, wherein determining the MCS according to the normalized signal quality comprises:
determining the MCS by locating the normalized signal quality in one of a plurality of quality regions.

7. The method of claim 6, wherein the plurality of quality regions are determined according to at least one threshold.

8. The method of claim 7, wherein one of the at least one threshold is adjusted according a HARQ transmission received by the receiver.

9. The method of claim 1, further comprising:
transmitting information of the MCS to the transmitter, for the transmitter to process the remaining part of the complete information in the next HARQ transmission according to the MCS.

10. The method of claim 1, wherein the signal quality comprises received signal-to-noise ratio (SNR) measured by the receiver.

11. The method of claim 1, wherein the complete information is a data unit.
